(19) United States
(12) Patent Application Publication
(10) Pub. No.: US 2024/0013198 A1
(43) Pub. Date: Jan. 11, 2024

(54) VALIDATE DIGITAL OWNERSHIPS IN IMMUTABLE DATABASES VIA PHYSICAL DEVICES

(71) Applicant: PlayStudios US, LLC, Belmont, CA (US)

(72) Inventors: Heinrich Fidencio Terborg, Mexico City (MX); Shih-Chien Lee, Belmont, CA (US)

(21) Appl. No.: 18/216,576

(22) Filed: Jun. 29, 2023

Related U.S. Application Data
(60) Provisional application No. 63/358,490, filed on Jul. 5, 2022.

(51) Int. Cl. G06Q 20/36; G06Q 20/38

(52) U.S. Cl. CPC G06Q 20/363; G06Q 20/3829

(57) ABSTRACT

A method or a system for validating digital ownership in immutable databases via physical devices. The system receives a request for accessing a secure resource from a client device of a user of an immutable database, and requests a wallet address associated with a wallet of the user from the client device of the user. Responsive to receiving the wallet address, the system requests an identifier (ID) token from the immutable database based on the wallet address, the ID token containing a first set of identity data of the user. The system also requests a second set of identity data from the client device. The system compares the first set of identity data with the second set of identity data to determine whether there is a match. Responsive to determining that there is the match, the system grants the user a permission to access the secure resource.

### CROSS-REFERENCE TO RELATED APPLICATIONS

This application claims priority to U.S. Provisional Patent Application Ser. No. 63/358,490, titled “Validate Digital Ownership Via a Physical Device to Allow Access to Restricted Services in the Physical World,” filed Jul. 5, 2022, which is incorporated herein by reference in its entirety.

### TECHNICAL FIELD

The present disclosure relates to validating digital ownership via physical devices, specifically to validating digital ownership in immutable databases (e.g., distributed ledgers) via physical devices to allow access to restricted resources in a physical world.

### BACKGROUND

Unlike physical assets, which can be easily identified and transferred, digital assets present unique challenges in terms of ownership verification. Traditional systems for tracking ownership, such as centralized databases or certificates, are susceptible to manipulation and hacking, undermining trust and transparency.

Immutable databases (e.g., distributed ledger or blockchain), the underlying technology behind cryptocurrencies, has gained widespread attention for its ability to establish trust in decentralized systems. A blockchain or a distributed ledger records transactions and information across a network of computers, making it resistant to tampering and ensuring transparency. By leveraging blockchain technology, it becomes possible to create a decentralized and secure system for verifying digital ownership. Verifying digital ownership in distributed ledgers is a decentralized verification process that can potentially eliminate intermediaries and streamline the ownership transfer process, and therefore reduces costs and improves efficiency. However, due to the pseudonymous nature of distributed ledgers, there is still challenge in verifying the ownership of digital items via distributed ledgers.

### SUMMARY

Embodiments described herein include a system and a method for validating digital ownership via physical devices and immutable databases to allow access to restricted services in a physical world. The system receives a request for accessing a secure resource from a client device of a user of an immutable database (e.g., a distributed ledger or a blockchain). Responsive to receiving the request, the system requests a wallet address associated with a wallet from the client device of the user, and requests an identifier (ID) token from the immutable database based on the wallet address. The ID token contains a first set of identity data of the user. Identity data includes a specific set of user information that is used to identify and/or authenticate the user. In some embodiments, identity data may include (but are not limited to) unique identifiers, personal information, or other data points that are associated with the user. The system requests a second set of identity data from the client device of the user. Responsive to receiving the second set of identity data of the user from the client device, the system compares the first set of identity data with the second set of identity data to determine whether there is a match. Responsive to determining that there is the match, the system grants the user permission to access the secure resource based in part on a determination of a match.

In some embodiments, the set of identity data includes a set of biometric data. The system causes the user to scan a set of biometric data, which may be performed via the client device or a gate system. Responsive to receiving the scanned biometric data of the user, the system compares the scanned set of biometric data with the set of biometric data contained in the ID token to determine whether there is a match.

In some embodiments, the first set of identity data contained in the ID token may be encrypted. The system determines whether the first set of identity data is encrypted. Responsive to determining that the first set of identity data is encrypted, the system requests for a decryption key from the client device of the user. Responsive to receiving the decryption key, the system decrypts the first set of identity data with the decryption key.

In some embodiments, the system further requires the client device to prove the user's control of content in the wallet. Proving of the user's control of content in the wallet may include requesting for an access token from the immutable database associated with the address of the wallet, requesting for content of the wallet from the client device of the user, and applying the access token to the content of the wallet to determine that the access token is valid. In some embodiments, proving of the user's control of content further includes determining that an identity of the user matches an identity of an owner of the wallet.

Other aspects include components, devices, systems, improvements, methods, processes, applications, computer readable mediums, and other technologies related to any of the above.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1A illustrates an example validation system in accordance with some embodiments.

FIG. 1B illustrates a communication pattern for an access granting process in accordance with some embodiments.

FIG. 2 illustrates example information components for an identity token in accordance with some embodiments.

FIG. 3 illustrates an example of identity (ID) token stacking in accordance with some embodiments.

FIGS. 4A-4B illustrate an example process of ID token verification in accordance with some embodiments.

FIG. 5 illustrates an example process of testing whether a user is an owner of a wallet in accordance with some embodiments.

FIG. 6 illustrates an example process for proof of control of content in a wallet in accordance with some embodiments.

FIG. 7 illustrates an example process for requesting access at a gate using a tokenized ID and proof of ownership in accordance with some embodiments.

FIG. 8 illustrates a flowchart of an example method for verifying ownership of a user of an immutable database via physical devices in accordance with some embodiments.

FIG. 9 is a flowchart of an example method for verifying ownership of a user of an immutable database via physical devices, where identity data in an ID token is encrypted, in accordance with some embodiments.

FIG. 10 is a flowchart of an example method for proving a user's control of a wallet in accordance with some embodiments.

FIG. 11 depicts a diagram of an example computer system in which embodiments of the present disclosure may operate.

### DETAILED DESCRIPTION

Ownership of digital items in immutable databases (distributed ledgers) may be used to enable users to access restricted resources. However, a significant challenge persists in verifying the true ownership of these digital items, such as access tokens, when an individual presents themselves physically or virtually at a particular location. This challenge arises due to the pseudonymous nature of existing distributed ledgers. While manual verification is an option, it can be an inconvenient and time-consuming process.

Embodiments described herein solve the above-described problem by using a physical device to facilitate access verification. The physical device may include (but is not limited to) a smartphone, a tablet, a wearable device, and/or a dedicated device. As such, a near field communication (NFC) card/tag, radio frequency identification (RFID), a quick response (QR) code can be read on-site via the physical device. Further, the physical device may also be able to obtain biometric data of the user in real time and allow the system to verify biometric data of an owner of the wallet, and/or biometric data of an owner of the required access token in the wallet.

In some embodiments, verification is used to allow a user to enter a virtual or physical area. For example, a user's age may be verified; and responsive to verifying the user's age, the user can enter an area (e.g., a bar area) where a minor's access is restricted. In some embodiments, verification is used to reduce friction in know your client (KYC) and anti-money laundry (AML) processes by providing an easy means of onboarding new users to software platforms, or by facilitating access control to specific events. In some embodiments, verification is used to provide proof of attendance.

Embodiments described herein include a system or a process for creating a digital identification (ID) token and a protocol for verifying its information in such a way that ownership of the digital ID token, control of a wallet, and contents in the wallet can be proven in an automated way. The system provides mechanisms for decentralizing the identity creation, and the ownership verification systems, so that the system can be used to grant access to specific areas (virtual or physical) with improved security. The system leverages an immutable database, such as a distributed ledger, or a blockchain, to provide a reliable point of reference for an identity check. The system can also leverage information regarding the verification track record from previous checks to increase security.

In an immutable database, a wallet is a placeholder for digital assets that all belong to a same user. Tokens are any kind of digital assets that can be transferred from one user's wallet to another user's wallet. Ownership is a provable connection between a digital asset (e.g., wallet, token, etc.) with a user (physical or moral). Proof of control is a provable demonstration that a user is able to transfer certain digital assets from a wallet. For instance, the user can demonstrate that they own keys to a digital wallet or have system wide permission to transfer certain kinds of digital assets. This is equivalent or similar to having proof that the user is able to spend the proceeds inside the wallet. An identity document is any officially issued or centralized issued identifier either in physical or digital format, or a decentralized identifier (DID). An immutable database may be (but is not limited to) a distributed ledger, a dedicated distributed ledger, a public blockchain, or a private blockchain. An access token is a digital item, for which, if ownership is proven, a client device or a user will be granted access to a physical or virtual area.

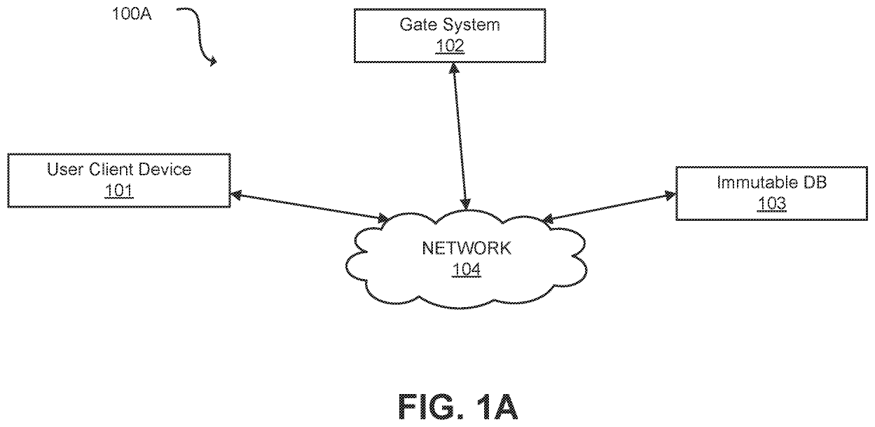

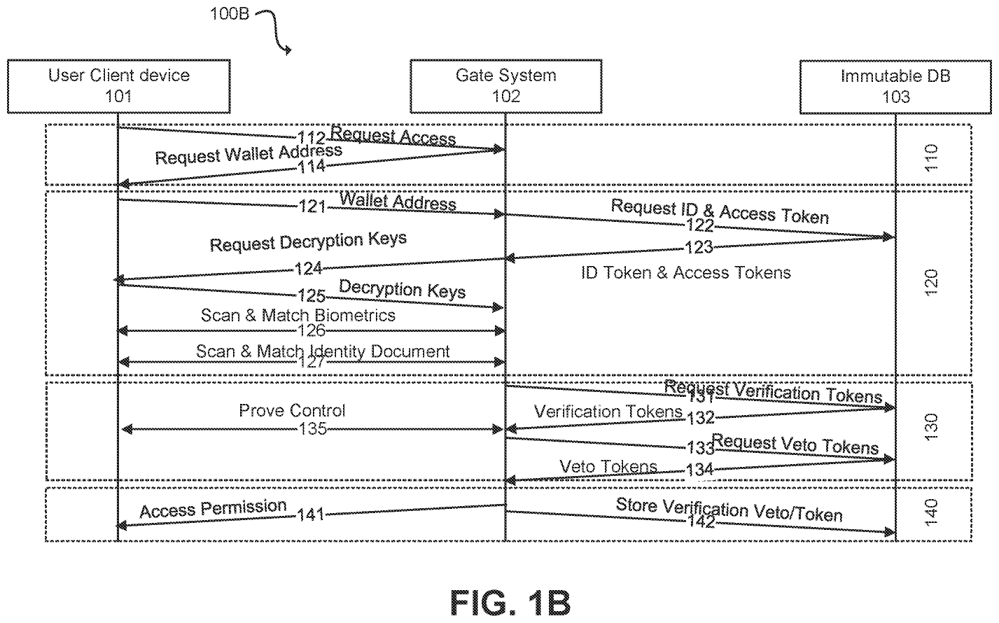

Referring now to FIG. 1A, it illustrates an example validation system 100A in accordance with some embodiments. The validation system 100A includes a user client device 101, a gate system 102, and an immutable database 103 configured to communicate with each other via a network 104. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

The user client device 101 may be (but is not limited to) a smartphone, a tablet, a wearable device, a laptop, a computer, and/or a dedicated device of a user. The immutable database 103 (which may be a distributed ledger or a blockchain) stores identity and access information. The gate system 102 is a computer system that provides a service that enables validation of digital ownership of users in the immutable database 103 via physical devices (such as user client device 101).

In some embodiments, the gate system 102 includes a gate server and a gate client device configured to communicate with each other via the network 104. The gate client device may be used by a gate keeper at an entrance of a physical area. In some embodiments, the gate client device may be able to communicate with the user client device 101 directly via a local area network (LAN), a personal network (e.g., Bluetooth low energy), RFID, QR code, NFC, etc. Responsive to receiving information from the user client device 101, the gate client device passes the received information to the gate server, which in turn performs validation of digital ownership of the user.

The network 104 is a collection of computing devices that communicate via wired or wireless connections. The network 104 may include one or more local area networks (LANs) or one or more wide area networks (WANs). The network 104, as referred to herein, is an inclusive term that may refer to any or all of standard layers used to describe a physical or virtual network, such as the physical layer, the data link layer, the network layer, the transport layer, the session layer, the presentation layer, and the application layer. The network 104 may include physical media for communicating data from one computing device to another computing device, such as MPLS lines, fiber optic cables, cellular connections (e.g., 3G, 4G, or 5G spectra), or satellites. The network 104 also may use networking protocols, such as TCP/IP, HTTP, SSH, SMS, or FTP, to transmit data between computing devices. In some embodiments, the network 104 may include Bluetooth or near-field communication (NFC) technologies or protocols for local communications between computing devices. The network 104 may transmit encrypted or unencrypted data.

FIG. 1B illustrates a communication pattern for an access granting process 100B in accordance with some embodiments. As illustrated, the process 100B includes multiple functional blocks or stages, such as (but not limited to) communication method agreement stage 110, an ownership check block 120, control and track record check stage 130, and/or result stage 140. In the communication method agreement stage 110, the user client device 101 and the gate system 102 may decide on a communication method that will be used during the access granting process 100B. This can be (but is not limited to) RFID, QR code, NFC, etc. For example, the user client device 101 sends an access request to the gate system 102 (represented by arrow 112). Responsive to receiving the request, the gate system 102 requests a wallet address from the user client device 101 (represented by arrow 114).

In the ownership check stage 120, the gate system 102 tries to establish if the user is the person who claims to be. As illustrated, in response to receiving a request wallet address from the gate system 102 (represented by arrow 114), the user client device 101 sends the wallet address to the gate system 102 (represented by arrow 121). It is often that the wallet contains a tokenized ID (also referred to as an ID token) and one or more access tokens. After receiving the wallet address, the gate system 102 can request the ID token and the one or more access tokens contained in the wallet from the immutable database 103 (represented by arrow 122), causing the immutable database 103 to send both the ID token and the access tokens to the gate system 102 (represented by arrow 123).

In some embodiments, the ID token contains identity data associated with the user, and the access tokens contain permission data associated with the user. Identity data includes a specific set of user information that is used to identify and/or authenticate the user. In some embodiments, identity data may include (but are not limited to) unique identifiers, personal information, or other data points that are associated with the user.

In some embodiments, the ID token and the access tokens may be encrypted. Responsive to determining that the ID token and/or the access tokens are encrypted, the gate system 102 may request decryption keys from the user client device 101 (represented by arrow 124), causing the user client device 101 to send the decryption keys to the gate system 102 (represented by arrow 125). Responsive to receiving the decryption keys, the gate system 102 can decrypt the identity data and/or permission data contained in the ID token and/or access tokens, and compare the decrypted identity data and/or permission data with the identity data and/or permission data received from the user client device 101. If the two sets of data match, the ownership check is successful; otherwise, the ownership check is failed.

In some embodiments, this stage 120 may leverage biometrics data and ID documents (represented by arrows 126 and 127). In some embodiments, the gate system 102 determines whether the ID token contains biometric data of the user. Responsive to determining that the ID token contains biometric data, the gate system 102 causes the user client device 101 to collect biometric data from the user, e.g., activating a fingerprint scanner, or facial recognition camera.

In some embodiments, the user client device 101 can also be used to show the required digital assets to the gate system 102. In the control and track record check stage 130, the gate system 102 tests whether or not the user is in control of the wallet (represented by arrow 135), e.g., the user in control of the wallet should be able to transfer items out of said wallet at will.

In some embodiments, the gate system 102 can also access the information gathered by previous verification checks from itself or from other gate systems to prevent fraudulent transaction from occurring (represented by arrows 131-134). For example, the gate system 102 may request previous verification tokens and/or veto tokens from the immutable database 103 (represented by arrows 131, 133). Once the gate system 102 receives the verification tokens and/or veto tokens from the immutable database 103, the gate system 102 grants or denies the requested access permission based not only on the proof of control 135, but also on the previous verification tokens and/or veto tokens received from the immutable database 103.

In the result stage 140, the gate system 102 grants or denies the requested access permission (represented by arrow 141), and the state of the access permission (whether granted or denied) is sent back to the immutable database 103 (represented by arrow 142), causing the immutable database 103 to store the state in a form of a verification token or a veto token. For example, when the access permission is granted, the immutable database 103 generates a verification token and stores data associated with the granting of the access permission in the verification token, and records the verification token in the immutable database 103. On the other hand, when the access permission is denied, the immutable database 103 generates a veto token and stores data associated with the denial of the access permission in the veto token, and stores the veto token in the immutable database 103. When a new verification request is received, the verification token or the veto token can later be retrieved, and be used by the gate system 102 in determining whether the new verification process should be granted or denied. In some embodiments, the state of access permission is also sent back to the user (whether granted or denied).

In some embodiments, the gate system 102 and/or the immutable database 103 are configured to include a tokenized ID (also referred to as “ID token”) system with a track record of verifications, and a process to link a tokenized ID with a wallet and provide proof of control. A tokenized ID solves the problem of having a reliable point of reference for comparing identity checks at gate systems. This ID token is meant to be stored in an immutable database to avoid tampering (e.g., double spending problem), and to facilitate tracking of any changes, such as transferring the token to another wallet or updating the token.

The token ID may have one or more of the following properties. First, there is no need for a central authority to issue it, and anyone with writing access to the immutable database is able to create such a token by using the decentralized tool intended for this purpose. Second, when the token is stored in a wallet, the system would interpret that this wallet and its contents are tied to a user whose identity matches that of the token. Yet, to avoid hijacking someone else's wallet by just creating an identity token and sending it to that wallet, additional requirements such as proof of control of that wallet may be required. Third, the token can be stacked to update an existing identity token with new information (e.g., biometric information or new identification documents). Fourth, since the token ID can hold sensitive information from a person, the information inside a token can be encrypted. This also adds the possibility of allowing users to remain pseudonymous (e.g., only known as the address of the wallet).

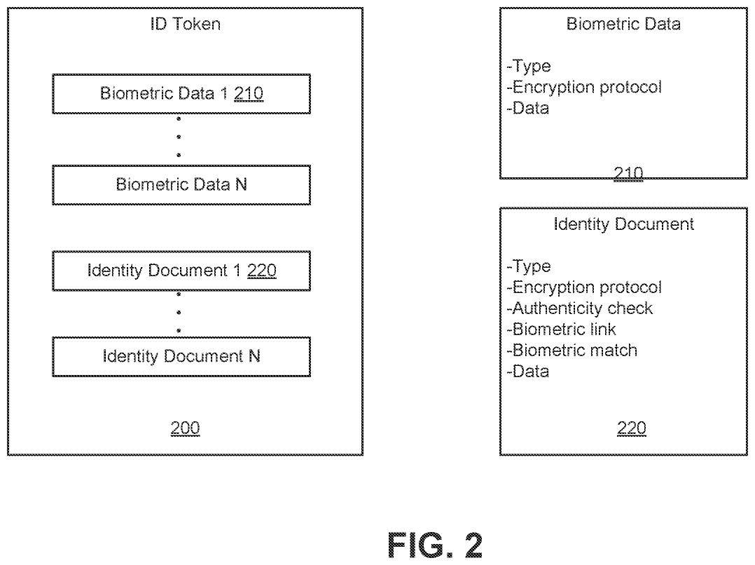

FIG. 2 illustrates example information components for an identity token in accordance with some embodiments. A typical ID token 200 may include one or more sets of biometric data 210, and/or one or more identity documents 220. A set of biometric data 210 includes a type of biometric data (e.g., fingerprint, facial recognition, retinal scan, palms scan, etc.). In some embodiments, a set of biometric data 210 also includes information regarding the format on how it was measured/scanned and stored. In case this data has to be encrypted, a set of biometric data 210 may also include an encryption protocol section, which will include any necessary information regarding how to treat the encrypted data or how to decrypt it.

An identity document 220 includes a type of identity (e.g., passport, driver's license, etc.). In some embodiments, an identity document 220 also includes a type of information provided by the document (e.g., name, photograph, fingerprint, address, age, etc.). In some embodiments, the identity information contained in an identity document 220 may also be encrypted, and the identity document 220 may also include encryption protocol which lets the reader know how to interpret the stored data and how to match the information. In some embodiments, an identity document 220 also may include information regarding the authenticity check performed on the document, such as how the document was checked for authenticity, and any score relating to the authenticity check (e.g., if it was an automatic computer visions inspection, a score of the confidence that the document is authentic will be added).

In some embodiments, an identity document 220 also may include biometric data related to the document. The biometric data may include a biometric link and/or biometric match data. The biometric link includes information about the set of biometric data 210 to which it was tied. For example, in case of a driver's license, the photograph might be tied via a facial match to a set of biometric data 210 containing face recognition data. Biometric match data may contain how strong the biometric link is. For instance, a measure of how close the facial match was between the driver's license photo and the set of biometric data 210. In some embodiments, this may be a service provided by a third party with a cryptographically signed result. Document data in an identity document 220 may include the actual data present in the document. In some embodiments, the document data is encrypted. In some embodiments, some portions of the document data may be directly stored as a cryptographic hash to facilitate information matching without having to exchange decryption keys.

In some embodiments, the gate system 102 provides a decentralized application accessible by users. In order to create an identity token, any user who desires to do so may access the decentralized application. In this decentralized application, all the necessary information for creating the token may be uploaded. The process can be aided by third party tools (such as document authenticity verification services, and liveness detection and biometric scanning services) that communicate with this decentralized application.

Depending on the information the user decides to add and the available biometric scanning devices, multiple types of biometric tokens may be defined, such as a simple verification, a biometrics with liveness verification, and full verification. Simple verification includes only biometrics. One or more sets of biometric data may be stored without any liveness requirement. This kind of token can be created as a first step, but they do not provide proof that a real person was present when biometrics were acquired. For instance, this can be created just from an image of the user. However, after several successful verifications (some of which test for liveness) the trust in this ID can increase.

Biometrics with liveness verification uses tokens besides biometrics. This type of biometrics verification includes a verification of liveness, which will be typically provided by a third party service with a cryptographically signed results. Full verification includes biometrics and liveness verification.

In some embodiments, a verification may also require verification of at least one identity document. For instance, these tokens can tie the legal name of a user to an ownership of a wallet. With this kind of token, reading a wallet and decrypting the information is enough to know who the bearer is.

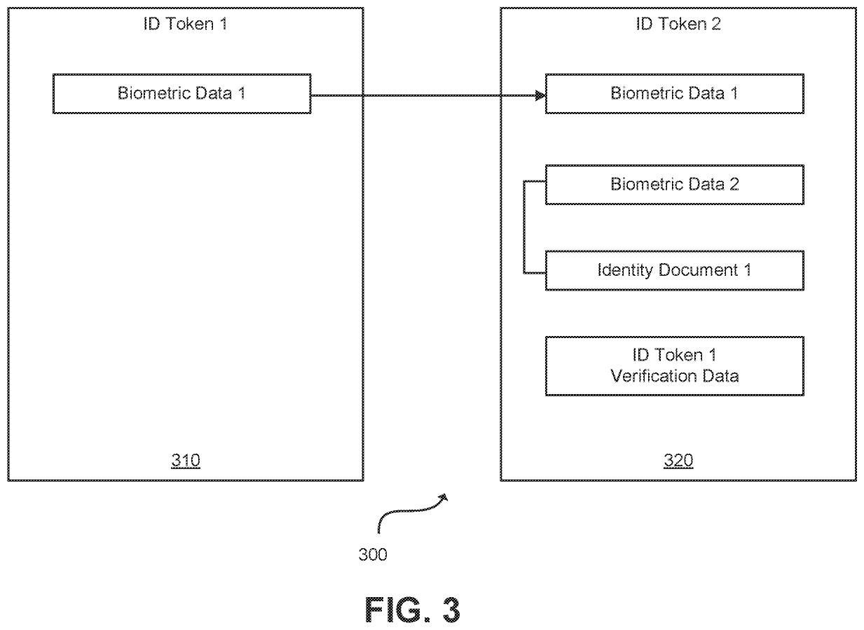

FIG. 3 illustrates an example of ID token stacking. The ID tokens can be upgraded by successively linking a new ID token 320 with a previously existing ID token 310. In order to provide a new linkage, it needs to add information from a successful biometric match between at least one set of biometric data from the old token 310 and the new token 320. This match is to ensure that both tokens refer to the same user. A set of successfully linked tokens is called a stack.

In some embodiments, to add a token to the stack, the user can upload the required information to the decentralized application. Linking can be repeated as often as needed, and the verification will often be performed against the last updated ID token. In some embodiments, all the tokens need to remain in the same wallet. This is because the verification will be done recursively, searching for statistics regarding previous verifications for all the tokens in the stack. For instance, a simple token 310 with a good track record can be upgraded to a “full verification” token by creating a new token 320 linked through the biometric data contained in the token 310.

In some embodiments, creating an identity token includes multiple steps. The system selects biometric data to include in the token. This depends mostly on the available biometric scanning devices (e.g., fingerprint, face recognition, voice, retina, palm, etc.). The system scans and saves a user's biometric data and encrypts the biometric data if required. In some embodiments, the system optionally adds identification documents. In some embodiments, adding identification documents may include adding authenticity check data, and adding a match between the IDs and the biometric data. In some embodiments, adding authenticity check data is provided by a third party document authentication service, and the result is cryptographically signed. In some embodiments, the match should comply with common thresholds to be accepted. In some embodiments, the system optionally selects a previous ID token. The system establishes a biometric match between the two tokens, and adds verification track record of the previous ID token to the biometric data. The system uploads the information (e.g., the biometric data and/or previous ID token) to the decentralized app that will then create the token and add the data from the wallet requesting the creation.

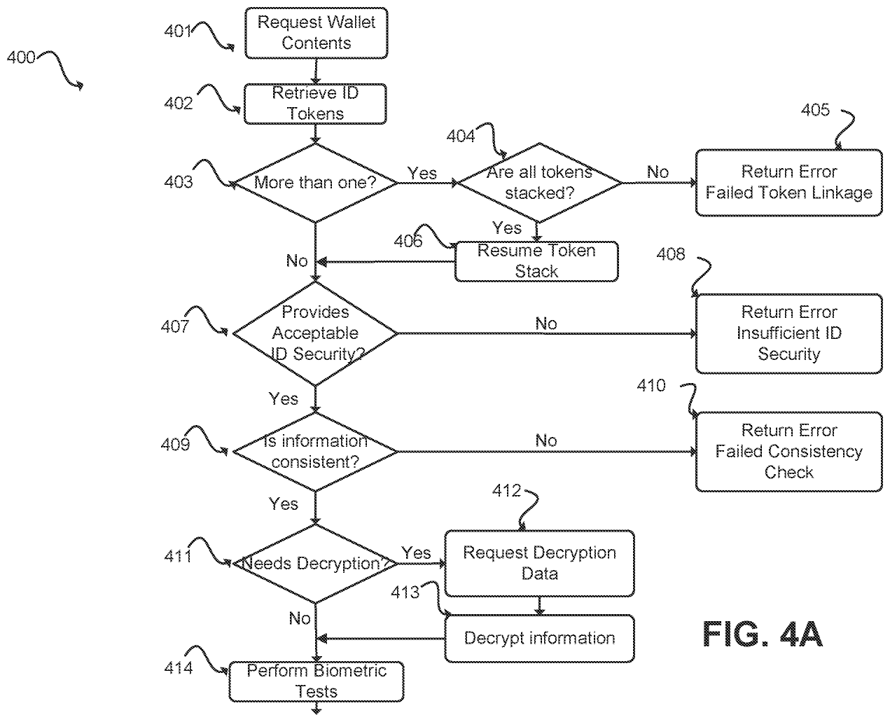

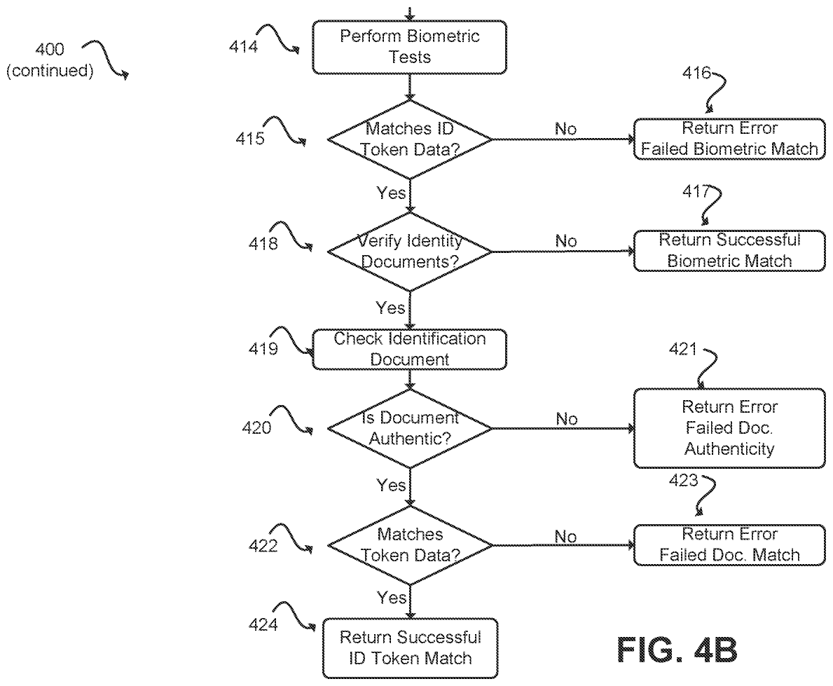

In some embodiments, an ID token verification process includes multiple steps. FIGS. 4A-4B illustrate an example process 400 of ID token verification in accordance with some embodiments. Alternative embodiments may include more, fewer, or different steps from those illustrated in FIGS. 4A-4B, and the steps may be performed in different order from that illustrated in FIGS. 4A-4B. The steps in process 400 may be performed by a gate system (e.g., gate system 102). In some embodiments, some of the steps in process 400 may also be performed by a combination of a gate system (e.g., gate system 102), a client device (e.g., client device 101), an immutable database (e.g., immutable database 103), and/or other third party services.

Referring to FIG. 4A, the gate system 102 retrieves 401 wallet contents, and retrieves 402 ID tokens. If there are no tokens, the process ends here at 403; alternatively, the gate system 102 determines 403 whether there is more than one ID token. If there is more than one token, the system checks 404 if all the tokens are correctly stacked. In some embodiments, if not all the tokens are correctly stacked, access is denied, and the error is returned 405. If all the tokens are correctly stacked, the gate system 102 resumes 406 token stack. Resuming 406 token stack includes retrieve information from the stacked ID tokens.

In some embodiments, if there is only one token, or the token stack is resumed, the gate system 102 reviews whether the information present in that token or token stack is enough or not for its own purposes. For example, in some embodiments, the gate system 102 determines whether the ID token provides 407 acceptable ID security. If the information present in the token or token stack is not enough, or the ID token does not provide acceptable ID security, an error is returned 408. This is because ID tokens can provide different varieties of data regarding biometric checks and different identification documents.

In some embodiments, the gate system 102 also checks 409 to see if the information contained in the ID tokens is consistent. This happens because the information from the token or token stack may need to be verified again. If the information is inconsistent, an error is returned 410. This can happen if the gate decides that a certain biometric link is too weak for its own security standards. In some embodiments, the gate system 102 also checks if the data that is needed by the gate system 102 needs to be decrypted 411. If so, the gate system 102 sends a request for decryption data (e.g., a decryption key) to the user's client device. Responsive to receiving decryption data from the user's client device, and the gate system 102 decrypts 413 information. In some embodiments, the gate system 102 also performs 414 biometric tests.

Referring to FIG. 4B, in some embodiments, performing 414 biometric tests includes obtaining live biometric data. In some embodiments, a biometric scan of the user at the gate system 102 or client device 101 is required. The gate system 102 determines 415 whether the acquired biometric data matches the corresponding biometric data block in the ID token. If the acquired biometric data matches the corresponding biometric data block in the ID token, the process can continue; otherwise, an error is returned 416. In some embodiments, the gate system 102 also determines 418 whether any identity documents should be verified. If the gate system 102 does not require verifying any identity documents (“no”), a successful biometric match can be returned 417. If the gate system 102 requires verifying an identity document (“yes”), the user (using the client device 101 or at the gate system 102) may be asked 419 to show an identification document that is also present in the ID token.

In some embodiments, this identity document may be checked 420 for authenticity using a third party service. If the document is not authentic according to the service (“no”), an error is returned 421. If the document is authentic (“yes”), the next step is to check whether or not it matches 422 the data stored in the ID token. If not (“no”), an error is returned 423. If there is a successful match (“yes”), the process will return 424 a successful ID token match.

In some embodiments, when the gate system 102 also performs a verification of an identity token, it can provide a track of the verification in the form of a token that can be useful for other gate systems. There are two types of tokens: verification tokens and veto tokens. A verification token is issued by the gate after a successful verification at the gate system's discretion. The token will be stored in the user's wallet, which means that the user will be in control of removing them or keeping them. A verification token may contain one or more of the following data: (1) a verification entity, (2) tokens and biometrics verified at the time and score of the verification, (3) a time stamp, (4) a verified ID token, (5) a wallet address where the ID token was in, (6) the score of the biometric data blocks matched, (7) if an identification document was verified, the score of the authentication and the biometric match with the document is added, (8) liveness verification score, (9) verification methods, and/or (10) third party services used.

Users have the incentive to keep these verification tokens because they provide a certifiable track record of successful checks of biometrics. The more verifiable tokens a user has in a wallet, the better the reputation and trust exist. Verification tokens also help to gather statistics for facilitating a future update of the biometric information (for instance, due to physical change of the person's biometrics) and they help migrate all the previous track record into an updated token to keep a high confidence level in the new ID token. In some embodiments, some gate systems might weigh verifications from other gate systems, to assign a higher degree of confidence to known gate systems. For instance, giving a higher value to a successful physical verification from a known trusted gate system, and a lower one to a virtual gate system.

A veto token is issued at the discretion of the gate when a bad actor has been discovered. These tokens will be sent to a special wallet so that they cannot be removed by the person whose ID token was reviewed. Since the final use of this information remains at the discretion of each gate system, it is a misbehaving gate system starts issuing veto tokens without any fundament, statistics will enable others to ignore any bad actors. In some embodiments, a veto token contains the same information as a verification token and an additional field containing the reason for issuing the veto. In the case of stacks, new successful verification tokens will only be issued for the last ID token. However, veto tokens will be created for all of the ID tokens in the stack in order to avoid fraud by just removing the last updated token. To facilitate gathering statistics, all the information regarding verification and veto tokens can be stored in a regular database (e.g., provided by a third party) which in turn points to the tokens in the immutable database to facilitate searching.

In some embodiments, an ID token on its own is not enough to prove that the user is the real owner of the wallet, or at least that it is in control of the wallet. For instance, a misbehaving user can send an ID token to someone else's wallet and try any access tokens in that wallet to access restricted areas. However, this user would not be able to transfer any items out of that wallet because, the user would not be in control of the keys.

In some embodiments, the gate system 102 is able to test for ownership of a wallet with identity verification. In some embodiments, the test is carried out by multiple gate systems. Proving ownership of a wallet implies that a user can be identified as the owner of the keys of the wallet. This is equivalent to the user being able to transfer out an unrestricted item from that wallet. In a macro level, the verification process includes reading wallet pointer, reading wallet contents, verifying biometric, and checking verification history statistics.

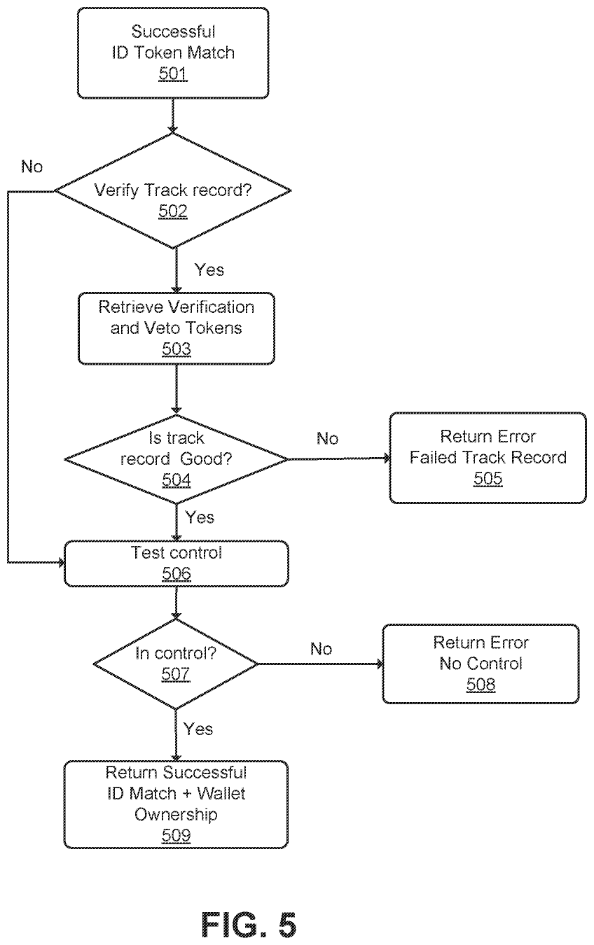

FIG. 5 illustrates an example process of testing whether a user is an owner of a wallet. Alternative embodiments may include more, fewer, or different steps from those illustrated in FIG. 5, and the steps may be performed in a different order from that illustrated in FIG. 5. The method may be carried out by a gate system (e.g., gate system 102).

By way of example, the process starts with a successful ID token match 501. The gate system 102 determines 502 whether there is a need to verify the track record, which depends on the gate system 102's security standard. If there is a need to verify the track record (“yes”), the gate system 102 retrieves 503 verification and veto tokens. The system may use statistics (e.g., weighting known trusted gate systems higher) to determine 504 whether the track record is good enough or not. If the track record is not good enough (“no”) (e.g., a veto token from a reliable source is found), an error is returned 505.

If the track record is good (“yes”), the gate system 102 tests 506 for control of the wallet keys. In some embodiments, when the gate system 102 determines 502 there is no need to verify the track record (“no”), the gate system 102 also tests 506 for control of the wallet keys. Various methods may be implemented to test for control of the wallet keys. In some embodiments, the gate system 102 can send another token to the wallet and expect the user to return it immediately. The gate system 102 determines 507 whether the control test is complete. If the test is not complete (or fails) (“no”), an error will be returned 508. If the test is completed (or passed) (“yes”), a successful ID match and wallet ownership notification are returned 509. At this point, the gate can be sure that the person is who the ID token says they are, and also that the person is in control of the wallet and thus, can perform transactions with the items in it.

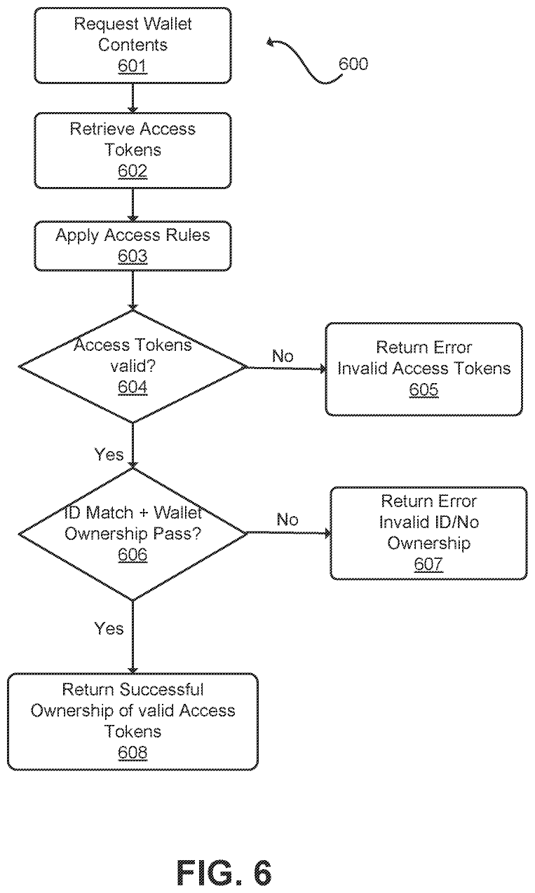

When access to a gate is restricted by the ownership of special access tokens following a predefined set of rules, the ownership of said access tokens by a user needs to be reliably proved in order to securely grant access. FIG. 6 illustrates an example process 600 for proof in accordance with some embodiments. Alternative embodiments may include more, fewer, or different steps from those illustrated in FIG. 6, and the steps may be performed in a different order from that illustrated in FIG. 6. The process 600 may be performed by a gate system (e.g., gate system 102).

In some embodiments, the gate system 102 requests 601 wallet contents. The gate system 102 also retrieves 602 access tokens. The gate system 102 applies 603 the access tokens to verify 604 whether the access tokens are valid. In some embodiments, verifying 604 whether the access tokens are valid includes verifying whether they comply with the predefined access rules. The gate system 102 may define rules or receive defined rules from a verifying entity. For instance, the rules could require having two tokens of one kind and one of another. If the access tokens are not valid or do not pass the rules, an error is returned 605. Otherwise, the gate system accesses 606 whether the ID matches the wallet ownership, which may correspond to the process 500 of FIG. 5.

If an ID matching a wallet ownership cannot be proven (“no”), an error is returned 607. If an ID matching a wallet ownership can be proven, a successful ownership of compliant access tokens is returned 608. At this point, the gate system 102 can be sure that the user is who the ID token says they are, and also that the user is in control of the wallet and owns access tokens compliant with the gate system 102's requirements.

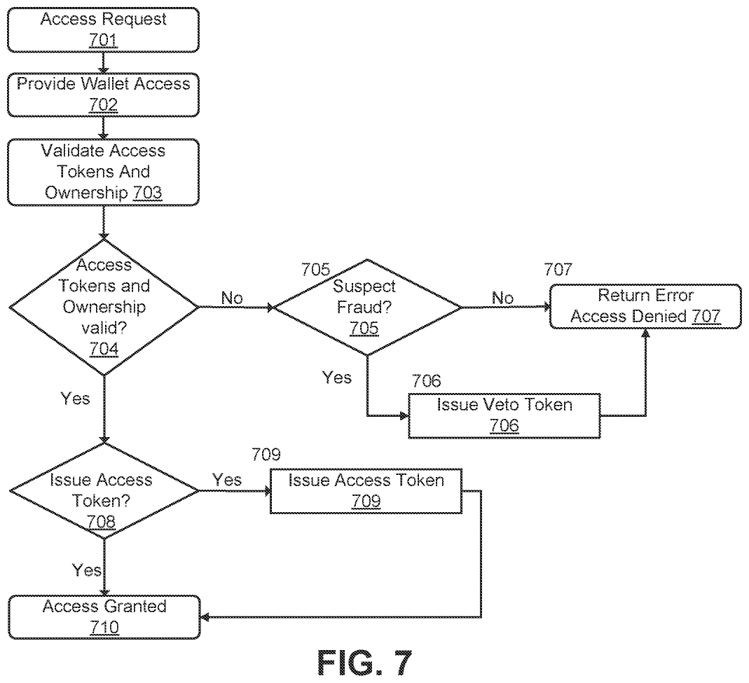

FIG. 7 illustrates an example process 700 for requesting access at a gate system using a tokenized ID and proof of ownership. Alternative embodiments may include more, fewer, or different steps from those illustrated in FIG. 7, and the steps may be performed in a different order from that illustrated in FIG. 7. These steps may be performed by a gate system (e.g., gate system 102).

The process 700 starts with accessing 701 a user request, requesting access to a secure resource at the gate system 102. At this point, the user and the gate system 102 may need to settle for the device and communication protocol they will be using for sending the wallet address and other information such as the decryption keys. The device and protocol selection will depend on whether this is a virtual or a physical gate system. Through the established communication channel, a user will provide the wallet address to the gate system. After the gate has received 702 the wallet address, it starts step 703 of validation of the access tokens and ownership, which may correspond to the process 600 of FIG. 6.

The gate system determines 704 whether the access tokens and ownership are valid. If the access tokens are not valid or ownership cannot be established, the gate system may decide, at its own discretion, if it suspects 705 fraud. If the user is suspected of fraud, a veto token will be issued including all the information regarding the verification and the fraud attempt 706. If the gate does not suspect fraud (for instance, if a technical problem with a biometric scanner occurred), an error message is returned 707. In some embodiments, the step 703 can be tried again at the gate system's discretion. If ownership and access token validity are established, the gate system then determines whether an access token is to be issued. If so, the gate system 102 issues 709 an access token, and grants 710 the user access to the requested secure resource.

The access granting process 700 works for both virtual and physical gate systems. The properties that differentiate them are described below. A virtual gate exists to allow access to virtual places such as a metaverse, a software platform, a website, etc. In some embodiments, biometrics and ID documents need to be checked remotely by a virtual gate system. In some embodiments, a virtual gate system can use a video feed to establish liveness and facial recognition. If not using a decentralized identity document (DID), physical ID documents may be sent as a scanned image. Stats of other verifications and vetoes play a more important role because if there is already a successful verification from a trusted physical gate system, the virtual gate system can leverage this information to provide increased security.

A physical gate allows access to physical places, which means the wallet address is retrieved in a physical location. Therefore, this requires a device at the gate that is capable of (1) receiving the wallet address (e.g., entry device), (2) scan biometrics (e.g., scanning device), (3) if required: identity document scanning/reading device. The physical gate checks biometrics and ID onsite, and stats of previous verifications and vetoes. Types of entry devices to retrieve the wallet addresses may include (but are not limited to) RFID tag or card, QR code, biometrics database, name database, NFC enabled devices, etc. An RFID tag or card contains the wallet address that can be scanned with the corresponding hardware. QR or similar code containing the wallet address can be scanned to retrieve the wallet address.

Biometrics database is a database containing a biometric match that is linked to the corresponding wallet address. For instance, a person's fingerprint match may be redirected to the correct pre-stored wallet address. Name database is a name search in a database containing a link to the corresponding wallet address. NFC enabled device may be a smart phone, a wearable device, card, etc. In some embodiments, only a wallet address is sent. Alternatively, besides providing the wallet address, the gate system 102 can require additional information to be sent from the client device 101 or the immutable database 103, such as information for correcting the data or even some of the decrypted data, which can also provide additional functionality such as providing proof of control.

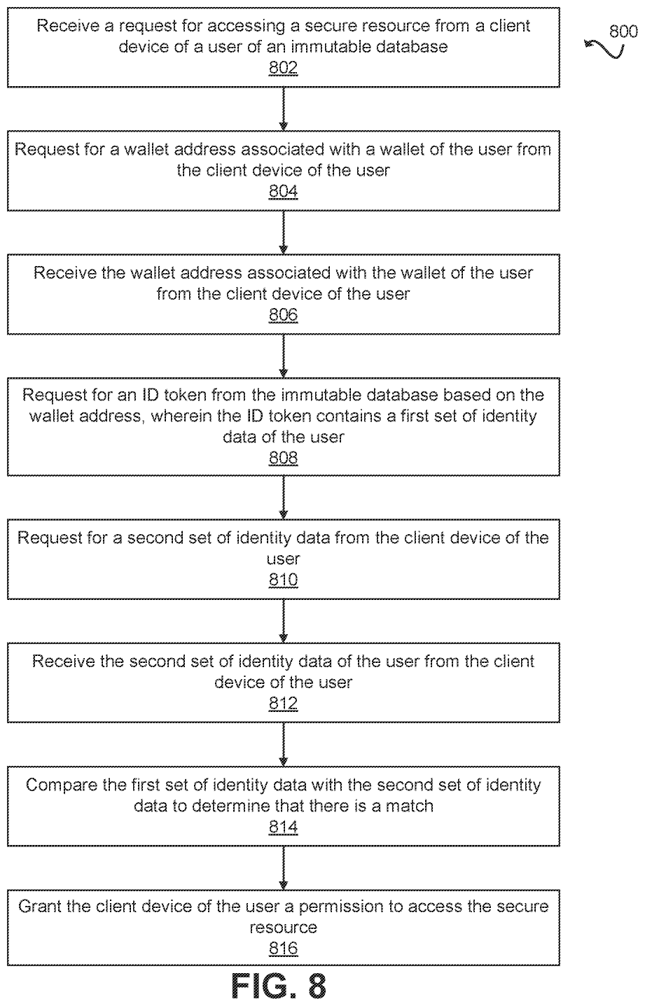

FIG. 8 illustrates a flowchart of an example method 800 for verifying ownership of a user of an immutable database via physical devices in accordance with some embodiments, which may correspond to the blocks 110 and 120 of FIG. 1B. The method 800 may be performed by the gate system 102 of FIG. 1A or 1B. Alternative embodiments may include more, fewer, or different steps from those illustrated in FIG. 8.

The gate system 102 receives 802 a request for accessing a secure resource from a client device of a user (e.g., user client device 101) of an immutable database (e.g., immutable database 103). The gate system 102 requests 804 for a wallet address associated with a wallet of the user from the client device of the user. The gate system 102 receives 806 the wallet address associated with the wallet of the user from the client device of the user.

The gate system 102 requests 808 for an ID token from the immutable database based on the wallet address. The ID token contains a set of identity data of the user (also referred to as a first set of identity data). The gate system 102 also requests 810 a second set of identity data from the client device of the user. Responsive to receiving 812 the second set of identity data of the user from the client device of the user, the gate system 102 compares 814 the first set of identity data with the second set of identity data to determine whether there is a match. Responsive to determining that there is a match, the gate system 102 grants 816 the client device of the user a permission to access the secure resource.

In some embodiments, the gate system 102 receives a plurality of ID tokens from the immutable databases. In some embodiments, the plurality of ID tokens includes a first ID token and a second ID token. The first ID token contains a first set of identity data of the user, and the second ID token contains a second set of identity data of the user. In some embodiments, the first ID token includes a pointer, linking to the first set of identity data contained in the first ID token, and verification data associated with the first ID token (e.g., encryption method, etc.).

In some embodiments, responsive to determining that multiple ID tokens are received, the gate system 102 determines whether the multiple ID tokens are linked to each other. Responsive to determining that the multiple ID tokens are not linked to each other, the gate system 102 returns an error indicating failed token linkage.

In some embodiments, the first set of identity data in the ID token is encrypted. The gate system 102 needs to perform additional steps to obtain a decryption key from the client device of the user, and decrypt the first set of identity data.

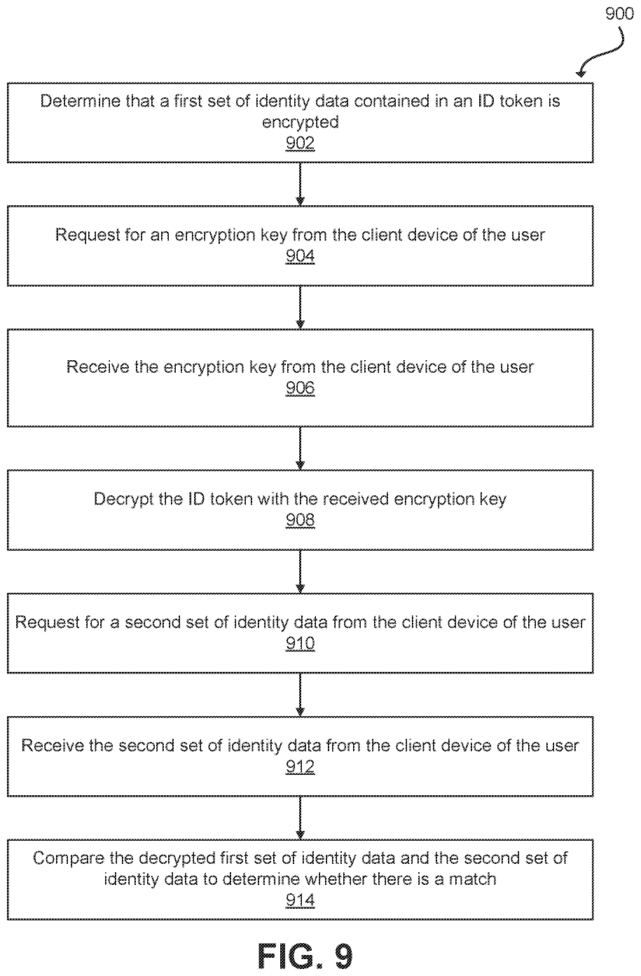

FIG. 9 is a flowchart of an example method 900 for verifying ownership of a user of an immutable database via physical devices, where identity data in an ID token is encrypted. The method 900 may be performed by the gate system 102 of FIG. 1A or 1B. Alternative embodiments may include more, fewer, or different steps from those illustrated in FIG. 9.

The gate system 102 determines 902 that a first set of identity data contained in an ID token is encrypted, where the ID token is received from an immutable database (e.g., immutable database 103). The gate system 102 requests 904 an encryption key from a client device of a user. Responsive to receiving 906 the encryption key from the client device of the user, the gate system 102 decrypts 908 the first set of identity data with the received encryption key. The gate system 102 also requests 910 a second set of identity data from the client device of the user. Responsive to receiving 910 the second set of identity data, the gate system 102 compares 914 the decrypted first set of identity data and the second set of identity data to determine whether there is a match.

In some embodiments, the gate system 102 determines that the first set of identity data is biometric data of the user, e.g., fingerprint, facial data, etc. Responsive to determining that the first set of identity data is biometric data, the gate system 102 causes the client device of the user to scan the biometric data of the user. In some embodiments, the gate system 102 further requests a verification token or a veto token from the immutable database, wherein the verification token or the veto token was generated during a previous verification process. In some embodiments, the gate system 102 further causes the client device to prove that the user has control over the wallet. The gate system 102's granting the user permission to access the secure resource is further based in part on the verification token and/or proving that the user has control over the wallet.

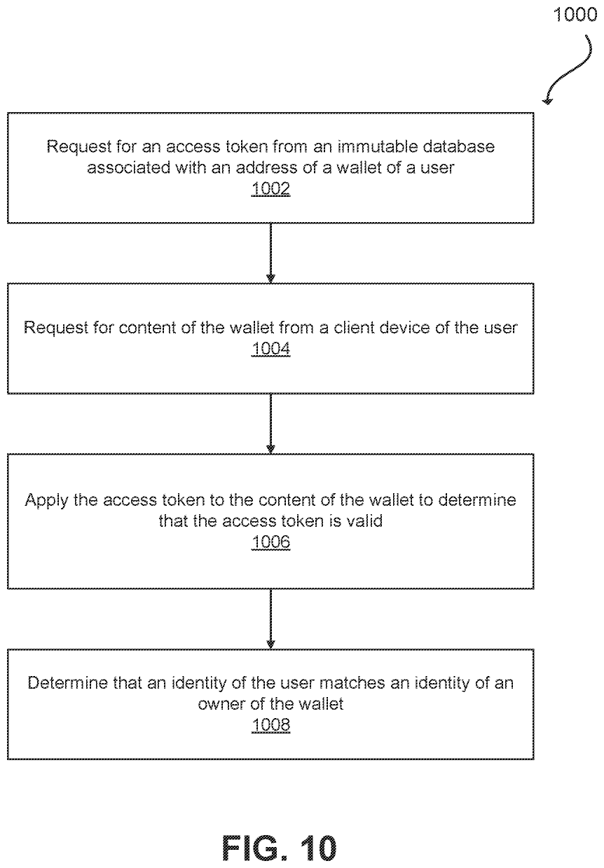

FIG. 10 illustrates a flowchart of an example method 1000 for proving that a user has control over a wallet. The method 1000 may be performed by the gate system 102 of FIG. 1A or 1B. Alternative embodiments may include more, fewer, or different steps from those illustrated in FIG. 10.

The gate system 102 requests 1002 an access token from an immutable database (e.g., immutable database 103), where the access token is associated with an address of a wallet of a user. The gate system 102 requests 1004 for content of the wallet from a client device of the user. The gate system 102 applies 1006 the received access token to the content of the wallet to determine that the access token is valid. The gate system 102 may also determine 1008 that an identity of the user matches an identity of an owner of the wallet

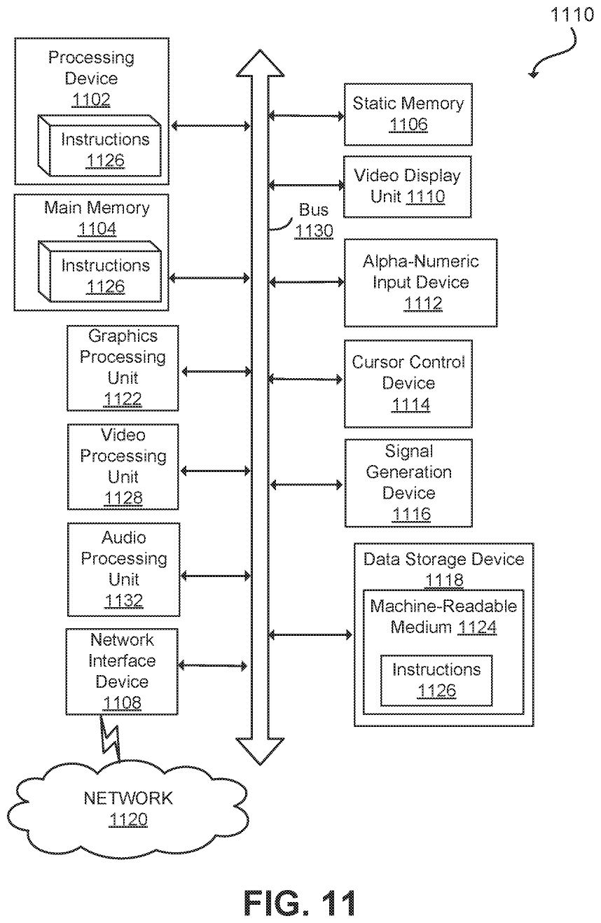

Notably, each of the client device 101, gate system 102, and/or immutable database 103 may include one or more computer systems. FIG. 11 illustrates an example machine of a computer system 1100 within which a set of instructions, for causing the machine to perform any one or more of the methodologies discussed herein, may be executed, e.g. the processes described with FIGS. 4A through FIG. 10. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PCa Personal Digital Assistant (PDA), a smartphone, a web appliance, a server, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1100 includes a processing device 1102, a main memory 1104 (e.g., read-only memory (ROM), flash memory, dynamic random access memory (DRAM) such as synchronous DRAM (SDRAM), a static memory 1106 (e.g., flash memory, static random access memory (SRAM), etc.), and a data storage device 1118, which communicate with each other via a bus 1130.

Processing device 1102 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1102 may also be one or more special-purpose processing devices such as an application specific integrated circuit (ASIC), a field programmable gate array (FPGA), a digital signal processor (DSP), network processor, or the like. The processing device 1102 may be configured to execute instructions 1126 for performing the operations and steps described herein.

The computer system 1100 may further include a network interface device 1108 to communicate over the network 1120. The computer system 1100 also may include a video display unit 1110 (e.g., a liquid crystal display (LCD) or a cathode ray tube (CRT)), an alphanumeric input device 1112 (e.g., a keyboard), a cursor control device 1114 (e.g., a mouse), a graphics processing unit 1122, a signal generation device 1116 (e.g., a speaker), graphics processing unit 1122, video processing unit 1128, and audio processing unit 1132.

The data storage device 1118 may include a machine-readable storage medium 1124 (also known as a non-transitory computer-readable medium) on which is stored one or more sets of instructions 1126 or software embodying any one or more of the methodologies or functions described herein. The instructions 1126 may also reside, completely or at least partially, within the main memory 1104 and/or within the processing device 1102 during execution thereof by the computer system 1100, the main memory 1104 and the processing device 1102 also constituting machine-readable storage media.

In some implementations, the instructions 1126 include instructions to implement functionality corresponding to the present disclosure. While the machine-readable storage medium 1124 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 1102 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
receiving a request for accessing a secure resource from a client device of a user of an immutable database;
requesting a wallet address associated with a wallet of the user from the client device of the user, wherein the wallet is a placeholder for digital assets owned by a same user;
requesting, responsive to receiving the wallet address, an identifier (ID) token from the immutable database based on the wallet address, wherein the ID token containing a first set of identity data encrypted by an encryption protocol;
requesting a second set of identity data from the client device of the user;
comparing, responsive to receiving the second set of identity data of the user from the client device, the first set of identity data and the second set of identity data to determine whether there is a match; and
granting, responsive to determining that there is the match, the user a permission to access the secure resource based in part on the determination of the match.

2. The method of claim 1, wherein the first set of identity data comprises a set of biometric data, and the method comprising:
causing the user to scan a set of biometric data at the client device or at a gate system; and
comparing the scanned set of biometric data with the set of biometric data contained in the ID token to determine whether there is a match in response to receiving the scanned biometric data of the user from the client device or the gate system.

3. The method of claim 1, further comprising:
determining whether the first set of identity data is encrypted;
requesting a decryption key from the client device of the user in response to determining that the first set of identity data is encrypted; and
decrypting the first set of identity data with the decryption key in response to receiving the decryption key.

4. The method of claim 1, further comprising receiving a plurality of ID tokens from the immutable database.

5. The method of claim 4, wherein the plurality of ID tokens comprises a first ID token and a second ID token, the first ID tokens contains a first set of identity data, and the second ID token contains a second set of identity data.

6. The method of claim 4, wherein the plurality of ID tokens comprises a first ID tokens and a second ID token, the first ID token contains a set of identity data, the second ID token contains a pointer, linking to the first set of identity data contained in the first ID token, and verification data associated with the first ID token.

7. The method of claim 6, further comprising:
determining whether the plurality of ID tokens are linked to each other in response to determining that a plurality of ID tokens are received; and
returning an error indicating failed token linkage in response to determining that the plurality of ID tokens are not linked to each other.

8. The method of claim 1, further comprising:
requesting a verification token from the immutable database, wherein the verification token was generated during a previous verification process; and
causing the client device to prove that the user has control over the wallet; wherein granting the user permission to access the secure resource further based in part on the verification token or proving that the user has control over the wallet.

9. The method of claim 8, wherein causing the client device to prove that the user has control over the wallet comprises:
requesting an access token from the immutable database associated with the address of the wallet;
requesting content of the wallet from the client device;
applying the access token to the content of the wallet to determine that the access token is valid; and
determining that an identity of the user matches an identity of an owner of the wallet.

10. The method of claim 9, further comprising:
requesting a veto token from the immutable database in response to determining that the client device fails to prove that the user has control over the wallet;
responsive to receiving the veto token, denying access permission.

11. The method of claim 10, further comprising storing the verification token or the veto token in the immutable database in response to granting or denying access permission.

12. A computer program product comprising a non-transitory computer readable medium comprising stored instructions encoded thereon that, when executed by pone or more processors, causes the one or more processors to:
receive a request for accessing a secure resource from a client device of a user of an immutable database;
request a wallet address associated with a wallet of the user from the client device of the user, wherein the wallet is a placeholder for digital assets owned by a same user;
request an identifier (ID) token from the immutable database based on the wallet address if the wallet address is received, wherein the ID token containing a first set of identity data encrypted by an encryption protocol;
request a second set of identity data from the client device of the user;
compare the first set of identity data and the second set of identity data to determine whether there is a match if the second set of identity data of the user is received from the client device; and
grant the user a permission to access the secure resource based in part on the determination of the match if determined there is a match.

13. The computer program product of claim 12, wherein the first set of identity data comprises a set of biometric data, and the non-transitory computer readable medium further comprising stored instructions that, when executed by the one or more processors, causes the one or more processors to:
cause the user to scan a set of biometric data at the client device or at a gate system;
compare the scanned set of biometric data with the set of biometric data contained in the ID token to determine whether there is a match if the scanned biometric data of the user from the client device or the gate system is received.

14. The computer program product of claim 12, the non-transitory computer readable medium further comprising stored instructions that, when executed by the one or more processors, causes the one or more processors to:
determine whether first set of identity data is encrypted;
determine a decryption key from the client device of the user if the first set of identify data is encrypted; and
decrypt the first set of identity data with the decryption key if the decryption key is received.

15. The computer program product of claim 12, the non-transitory computer readable medium further comprising stored instructions that, when executed by the one or more processors, causes the one or more processors to:
receive a plurality of ID tokens from the immutable database.

16. The computer program product of claim 15, wherein the plurality of ID tokens comprises a first ID token and a second ID token, the first ID tokens contains a first set of identity data, and the second ID token contains a second set of identity data.

17. The computer program product of claim 16, wherein the plurality of ID tokens comprises a first ID tokens and a second ID token, the first ID token contains a set of identity data, the second ID token contains a pointer, linking to the first set of identity data contained in the first ID token, and verification data associated with the first ID token.

18. The computer program product of claim 17, the non-transitory computer readable medium further comprising stored instructions that, when executed by the one or more processors, causes the one or more processors to:
determine whether the plurality of ID tokens are linked to each other if a plurality of ID tokens are received; and
return an error indicating failed token linkage if the plurality of ID tokens are not linked to each other.

19. The computer program product of claim 12, the non-transitory computer readable medium further comprising stored instructions that, when executed by the one or more processors, causes the one or more processors to:
store a verification token or a veto token in the immutable database in response to granting or denying access permission;
receive a second request for accessing the secure resource from the client device of the user of the immutable database;
request the verification token or the veto token associated with a previous request from the immutable database; and
grant or denying the user a permission to access the secure resource further based in part on the verification token or veto token associated with the previous request.

20. A computer system, comprising:
a processor, and
a non-transitory computer readable medium having instructions encoded thereon that, when executed by the processor, cause the processor to:
receive a request for accessing a secure resource from a client device of a user of an immutable database;
request a wallet address associated with a wallet of the user from the client device of the user, wherein the wallet is a placeholder for digital assets owned by a same user;
request an identifier (ID) token from the immutable database based on the wallet address if the wallet address is received, wherein the ID token containing a first set of identity data encrypted by an encryption protocol;
request a second set of identity data from the client device of the user;
compare the first set of identity data and the second set of identity data to determine whether there is a match if the second set of identity data of the user is received from the client device; and
grant the user a permission to access the secure resource based in part on the determination of the match if determined there is a match.
